(19) United States
(12) Patent Application Publication
(10) Pub. No.: US 2015/0102775 A1
(43) Pub. Date: Apr. 16, 2015

(54) SYSTEMS, METHODS, AND DEVICE FOR INTELLIGENT ELECTRIC VEHICLE SUPPLY EQUIPMENT

(71) Applicant: QUALCOMM Incorporated, San Diego, CA (US)

(72) Inventors: William Henry Von Novak, III, San Diego, CA (US); Linda Stacey Irish, San Diego, CA (US)

(73) Assignee: QUALCOMM Incorporated, San Diego, CA (US)

(21) Appl. No.: 14/054,628

(22) Filed: Oct. 15, 2013

(51) Int. Cl. B60L 11/18

(52) U.S. Cl. CPC B60L 11/1809; B60L 11/1844
USPC 320/109; 320/137

(57) ABSTRACT

Systems, methods, and devices for electric vehicle charging are described herein. In some aspects, a device for delivering power includes an environment sensor configured to generate a signal indicative of the sensed input and a controller operably connected to the environment sensor and configured to cause an adjustment of an amount of power drawn by an electric vehicle charger based on the generated signal. The device may further include an antenna operably connected to the controller and configured to transmit and receive broadcast signals from a plurality of other such devices via a personal area network, wherein the controller is configured to generate a cooperative charging policy for dividing power among a plurality of electric vehicle chargers based on the received signals.

### FIELD

The present application relates generally to electric vehicle charging, and more specifically to systems, methods, and devices for intelligent electric vehicle supply equipment.

### BACKGROUND

Electric vehicles and plug-in hybrid electric vehicles comprise an increasing percent of vehicles on the road. Electric vehicles are charged by electric vehicle supply equipment (EVSE), which may draw full power for most of the time that the electric vehicle is connected. In many cases, electrical distribution systems are sized for average loads but not peak loads. There is a risk of overload during peak power demand hours when electric vehicle chargers, climate control systems, lights, and computers are all running at once. Increased energy consumption by electric vehicles during peak hours can potentially lead to power overload and subsequent brownouts by the utility company. Also, increased local power loads may trip home or office circuit breakers, causing a nuisance and preventing electric vehicles from charging until the circuit is reset. Accordingly, there is a need for improved systems, methods, and devices for electric vehicle supply equipment.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the subject matter described in the disclosure provides a device for delivering power. The device comprises an environment sensor configured to sense an input and generate a signal indicative of the sensed input. The device further comprises a controller operably connected to the environment sensor and configured to cause an adjustment of an amount of power drawn by an electric vehicle charger based on the generated signal.

Another aspect of the subject matter described in the disclosure provides a method for delivering power. The method comprises sensing an input via an environment sensor. The method further comprises adjusting an amount of power drawn by an electric vehicle charger based on the sensed input.

Another aspect of the subject matter described in the disclosure provides a device for delivering power. The device comprises means for sensing an environmental input. The device further comprises means for adjusting an amount of power drawn by an electric vehicle charger based on the sensed environmental input.

Another aspect of the subject matter described in the disclosure provides a non-transitory computer-readable medium comprising code that, when executed, causes a device for delivering power to sense an input via an environmental sensor. The non-transitory computer readable medium further comprises code that, when executed, causes the device for delivering power to adjust an amount of power drawn by an electric vehicle charger based on the sensed input.

### BRIEF DESCRIPTION OF THE DRAWINGS

FIG. 1A illustrates an electric vehicle charging system in which aspects of the present disclosure may be employed.

FIG. 1B illustrates a wireless electric vehicle charging system in which aspects of the present disclosure may be employed.

FIG. 2 illustrates a simplified box diagram of an EVSE that may be employed within an electric vehicle charging system.

FIG. 3 illustrates a simplified box diagram of an exemplary intelligent EVSE in accordance with certain embodiments described herein.

FIG. 4 illustrates an exemplary electric vehicle charging system including a plurality of electric vehicles utilizing intelligent EVSEs in accordance with certain embodiments described herein.

FIG. 5 shows a chart of peak power demand and electric vehicle power draw in accordance with certain embodiments described herein.

FIG. 6 shows a chart of electric vehicle power draw between a plurality of electric vehicles in accordance with certain embodiments described herein.

FIG. 7 shows a flowchart for an exemplary method for charging an electric vehicle in accordance with certain embodiments described herein.

FIG. 8 shows a block diagram of an exemplary device for charging in accordance with certain embodiments described herein.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different electric vehicle technologies, configurations, charging levels, and standards, some of which are illustrated by way of example in the figures and in the following description of the preferred aspects. The detailed description and drawings are merely illustrative of the disclosure rather than limiting, the scope of the disclosure being defined by the appended claims and equivalents thereof.

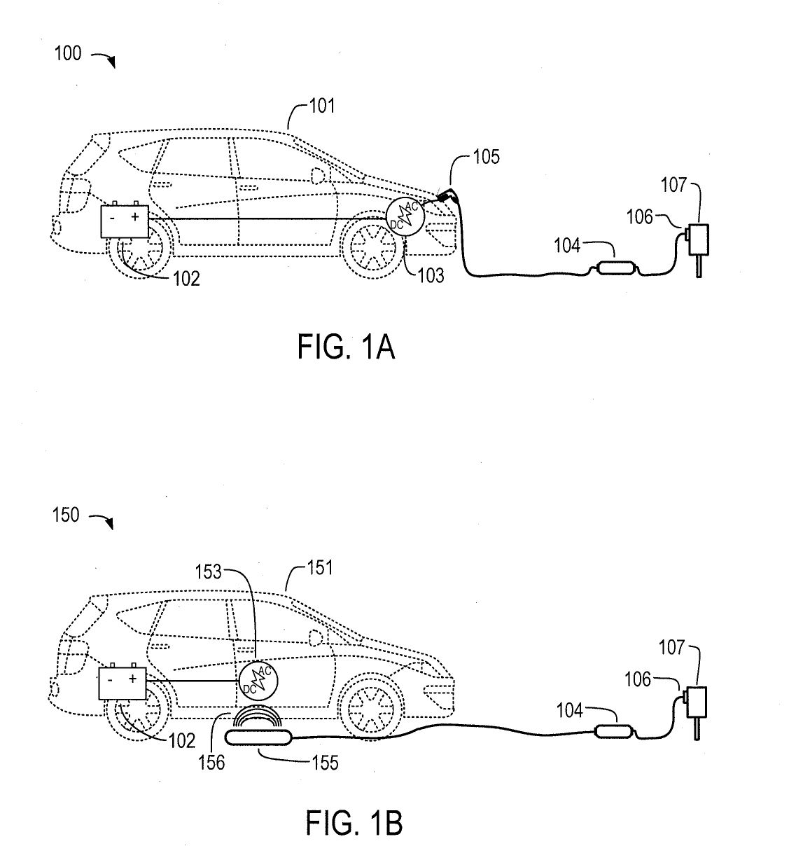

FIG. 1A illustrates an electric vehicle charging system 100. An electric vehicle (EV) 101 includes a battery 102 and an on-board electric vehicle charger 103. EV charger 103 converts alternating current (AC) energy to regulated direct current (DC) to charge battery 102. Battery 102 provides the power to drive the electric motor of EV 101. As a result of constant use, EV 101 requires the battery 102 to be constantly charged. Electric vehicle supply equipment (EVSE) 104 is used to charge EV 101 and may provide an interface between an electric vehicle charger and the power grid. EVSE 104 is configured to operate safely by establishing a reliable grounding path and exchanging control information with electric vehicle charger 103. In one embodiment, EVSE 104 uses conductive charging to deliver energy to EV 101 from the power grid and includes a conductive charge coupler 105 for mating to the inlet of EV charger 103. In another implementation, EVSE 104 includes an inductive coupler instead. EVSE 104 also includes a power plug 106 for connecting to electric receptacle 107 which provides AC power from the power grid. In the United States, electric vehicle charging system 100 may conform to a standard such as the SAE J1772 standard. The SAE J1772 standard allows for level 1 and level 2 AC charging. Level 1 charging uses an electric receptacle at 120 vac. Level 2 charging uses dedicated EV supply equipment to provide 208 to 240 vac. In Europe, the electric vehicle charging system 100 may conform to the IEC 62196 standard instead.

FIG. 1B illustrates a wireless charging system 150. Electric vehicle 151 includes an on-board wireless charger 153 configured to charge battery 102. In this implementation, EVSE 104 comprises a wireless charging pad 155 to wirelessly provide power to battery 102 via on-board wireless charger 153. On-board wireless charger 153 includes a wireless power antenna (not shown) configured to receive power. Wireless charging pad 155 includes a wireless power antenna (not shown) configured to transmit power. Wireless charging pad 155 receives the power provided by EVSE 104 and generates a magnetic field 156. On-board wireless charger 153 couples to the field 156 and converts the received power to DC power in order to charge battery 102. In some implementations, on-board wireless charger 153 and wireless charging pad 155 each include data antennas configured to send and receive data signals. The data signals include power control signals and alignment signals. In one implementation, EV 151 is configured to receive alignment signals in order to better position on-board wireless charger 153 over wireless charging pad 155 for charging. The wireless power antenna of on-board wireless charger 153 and the wireless power antenna of wireless charging pad 155 are configured to resonate at a resonant frequency in order to increase efficiency of wireless power transfer.

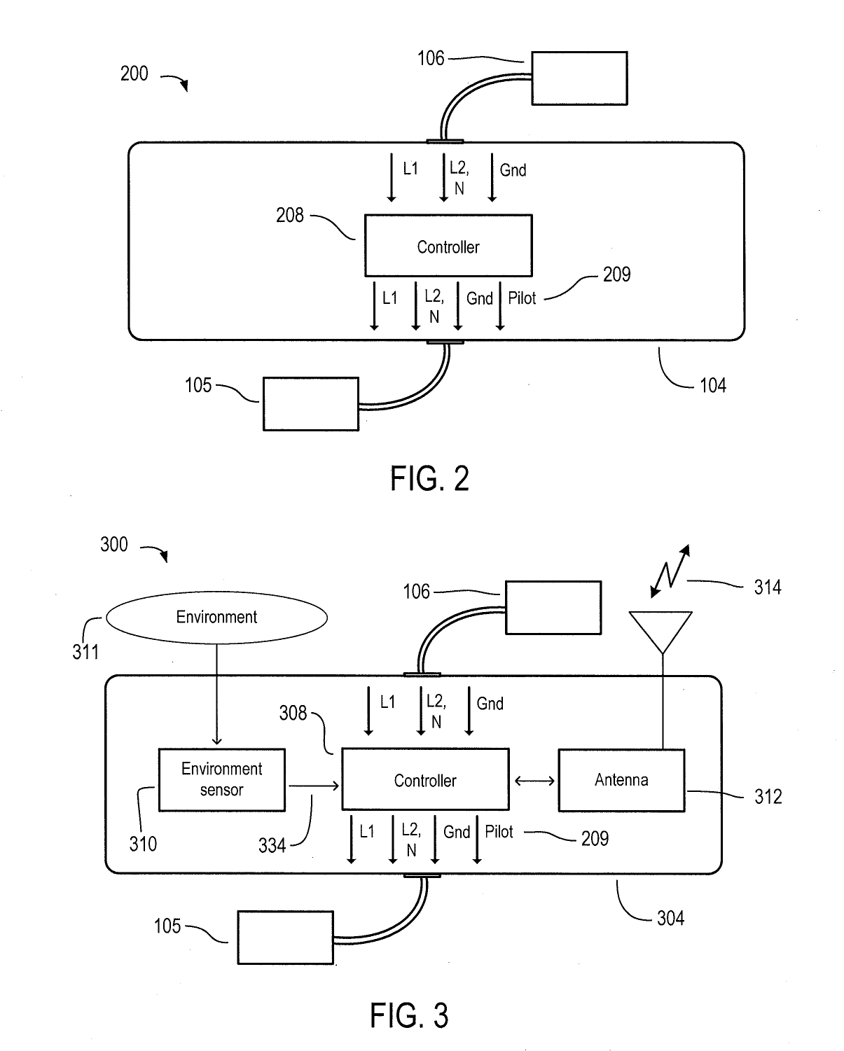

FIG. 2 illustrates an EVSE control system 200. Conductive charge coupler 105 provides a physical connection to EV charger 103. In another implementation, wireless charging pad 155 is used instead of conductive charge coupler 105. EVSE 104 includes a controller 208 which provides a control pilot signal 209 to EV charger 103. Pilot signal 209 is configured to indicate that EVSE 104 is ready to supply power to EV charger 103. EV charger 103 may then indicate that it is ready to accept energy from EVSE 104. EVSE 104 then indicates the maximum available continuous current capacity, and by inference the rating of the protective circuit breaker, to the EV charger 103. EV charger 103 will limit its current draw accordingly, so as to not overload the circuit. EVSE 104 may also include an optional data link (not shown) to allow information transfer between EV 101 and EVSE 104. Furthermore, EVSE 104 is configured to detect ground faults and to power down during unsafe operation.

FIG. 3 illustrates a simplified box diagram 300 of an exemplary intelligent EVSE 304. Intelligent EVSE 304 includes some of the same components as EVSE 104 but EVSE 304 implements additional components and features. EVSE 304 includes environment sensor 310 which is configured to sense an input and generate a signal 334 indicative of the sensed input. Environmental sensor 310 is configured to sense a property of the environment 311 that is local to the area in which EVSE 304 is located, for example of a parking area, parking garage, or home garage. As such, EVSE 304 is configured to adjust charging according to variations in the environment from place to place. Environment sensor 310 may be any one of a clock, a temperature sensor, an ambient light sensor, an ultra-violet light sensor, a humidity sensor, a wind speed sensor, a barometric sensor, or any other sensor configured to sense a property of the environment. Various sensors may be used in concert to calculate weather conditions and predict energy usage.

One benefit of incorporating an environment sensor 310 into EVSE 304 is that it allows EVSE 304 to independently and intelligently control power discharge without requiring outside control input from a user or operator. By sensing properties of the local environment through a variety of sensors, EVSE 304 can infer weather patterns, energy consumption, and power generation and then adjust electric vehicle charging accordingly.

In one implementation, environment sensor 310 is housed together with controller 308. The housing may be portable such that a user could carry EVSE 304 in their electric vehicle or by hand. In one implementation, EVSE 304 is configured to save the sensed information for each location and set default charging parameters based on the current location.

EVSE 304 further includes controller 308. Controller 308 is configured to receive signal 334 that is generated by environment sensor 310, generated signal 334 being indicative of the environment 311. Controller 308 is further configured to cause an adjustment of an amount of power drawn by an electric vehicle charger 103 based on the generated signal 334. In one implementation, controller 308 is configured to cause the adjustment of the amount of power drawn by the electric vehicle charger 103 by sending a message to EV charger 103. In one implementation, the message may be sent via control pilot signal 209 to EV charger 103. Pilot signal 209 may indicate the maximum available continuous current capacity, and by inference the rating of the protective circuit breaker. In addition, controller 308 may also use information the about the local environment 311 that it receives from environment sensor 310 to adjust pilot signal 209. For example, if controller 308 determines that the power grid is under a peak load time, it may signal to EV charger 103 that the available continuous current capacity is less than the actual available continuous current capacity of the local circuit. This will limit the charging rate of the electric vehicle accordingly. Furthermore, controller 308 may indicate that charging is not available, preventing EV charger 103 from drawing any power at all. In another implementation, controller 308 adjusts the power drawn by electric vehicle charger 103 by selectively discontinuing pilot signal 209.

In another implementation, EVSE 304 is configured to control the amount of power drawn based on a measured voltage. In this implementation, EVSE 304 comprises a voltage sensor (not shown) configured to sense a voltage and generate a signal indicative of the sensed voltage and controller 308 is configured to determine whether the voltage drop is below a threshold. Controller 308 is further configured to reduce the amount of power drawn by EV charger 103 (FIG. 1) in response. An EVSE 304 configured in this way is beneficial because it allows EVSE 304 to determine whether other loads are on the same circuit. All power systems contain some resistance and thus, result in a voltage drop. A system drawing power will cause a drop in voltage while a system reducing power draw will cause an increase in voltage. Using a voltage sensor allows EVSE 304 to infer to the load on the circuit without requiring any communications. EVSE 304 can also get an estimate of the branch capacity by allowing the electric vehicle charger 103 to draw a small load and then measuring the voltage drop. Since, in general, resistance is inversely proportional to branch circuit capacity, a large voltage drop would indicate that EVSE 304 should not draw maximum power.

In another implementation, EVSE 304 comprises a clock and controller 308 is further configured to determine whether the current time of day corresponds to a peak energy demand period and cause a reduction in the amount of power drawn in response. Too many electric vehicles charging during peak hours may strain the power grid and can potentially lead to an overload situation. Furthermore, electricity prices are higher than average during peak hours. One benefit of EVSE 304 being configured as in this implementation is that the cost to charge the electric vehicle is less expensive than it otherwise would be. Another benefit is that there is less strain on the power grid in general. In one implementation, EVSE 304 is preprogrammed with energy demand curves based on time and date. EVSE 304 may be further configured to adjust the demand curves over the course of operation based on the sensed inputs.

In another implementation, controller 308 may be configured to infer weather patterns from environment sensor 310. Controller 308 may further be configured to correlate the inferred weather patterns with periods of higher than usual or lower than usual demands on the power grid. For example, environment sensor 310 may comprise a temperature sensor and controller 308 may be configured to determine that a temperature above a certain threshold corresponds to a higher demand on the power grid. For instance, high temperatures may be correlated with increased air-conditioning usage. Controller 308 may be further configured to determine that a temperature below a certain threshold also corresponds to a higher demand on the power grid. For instance, low temperatures may be correlated with increased heater usage. Controller 308 is configured to reduce the amount of power drawn by electric vehicle 101, by adjusting pilot signal 209, during periods of time corresponding to high demand on the power grid. In one implementation, pilot signal 209 indicates a reduced available continuous current capacity instead of the actual capacity available from the electric receptacle 107. In some implementations, Controller 308 is configured to delay charging of electric vehicle .101 until after the high-demand period. In this instance controller 308 is configured to adjust pilot signal 209 to indicate that charging is not available.

In another implementation, environment sensor 310 may comprise an ambient light sensor or a UV light sensor and controller 308 may be configured to infer whether the measured inputs correspond to more or less solar power generation than usual. EVSE 304 is configured to reduce the power drawn by EV charger 103 if less solar power is being generated or increase the power drawn if more solar power is being generated. In another implementation, environment sensor 310 may comprise a wind speed sensor and controller 308 may be configured to infer whether the measured input corresponds to more or less wind power generation than usual and adjust the amount of power drawn by EV charger 103 accordingly. EVSE 304 may be configured to infer power generation from other renewable sources as well.

An EVSE 304 that is configured to infer power generation from renewable sources is beneficial because many utility entities, and even homes and offices, now generate a significant amount of energy from renewable sources. By inferring renewable energy generation rates, EVSE 304 is able to adjust the amount of power drawn by an electric vehicle according.

In another implementation, EVSE 304 further comprises a GPS sensor configured to detect the EVSEs 304 location. In this instance controller 308 is further configured to cause the adjustment of power in response to the EVSEs 304 location. In other implementation, EVSE 304 may comprise a plurality of environment sensors 310 that can be used to infer demand on the power grid and adjust the power drawn by an electric vehicle charger accordingly.

Another benefit of EVSE 304 as described above is that is can reduce electric vehicle demand on the power grid at times where the demand is already high. For example, on a particularly hot day air-conditioning units may already be drawing a large amount of power. If a substantial amount of electric vehicles were charging at the same time, the demand might surpass the capacity of the local power grid. However, if the EVSEs were able to intelligently reduce their power draw on such a hot day, the power grid would be more able to handle the power demands.

In another implementation, EVSE 304 may further comprise an antenna 312. Antenna 312 is connected to the controller 308 and is configured to transmit and receive signals 314 to and from a plurality of other devices for delivering power, such as other EVSEs 304, via a personal area network. In one implementation, signals 314 are broadcast signals. The personal area network may be configured to operate as a peer to peer network or as a wireless ad-hoc network. In this implementation the controller 308 is further configured to generate or operate according to a cooperative charging policy for dividing power among a plurality of electric vehicle chargers 103 based on the received broadcast signals 314. Each controller 308 is further configured to cause an adjustment of power drawn by its connected electric vehicle charger 103 based on the cooperative charging policy. Each EVSE 304 within range of a broadcast signal 314 range may receive the broadcast signals 314 and forward the signal to the other EVSEs 304 such that all EVSEs 304 operate according to the same charging policy. In another implementation, one EVSE 304 aggregates the broadcast signals 314 and creates a single policy that it distributes to the other EVSEs 304.

Broadcast signals 314 may contain information on battery charge level, maximum battery storage level, length of time charging, estimated time until charging complete, whether the electric vehicle is hybrid or battery only, and priority information. In one implementation the cooperating charging policy is defined to reduce power to the highest powered EV chargers 103. In another implementation, the cooperative charging policy is defined to reduce power to the EV chargers 103 that are the closest to being full charged. In another implementation, the cooperative charging policy is defined to reduce power randomly or evenly. In another implementation, the cooperative charging policy is defined to adjust power only to EV chargers 103 that share a common circuit.

EVSE 304 may communicate via a variety of methods. Antenna 312 may be configured to comply with one of many short range wireless communication standards, including Bluetooth, Zigbee, Radiowire, and 802.11. The advantage of these communication methods is that they do not require an FCC license. Furthermore, these short range LANs do not require any integration into another established network. One disadvantage of short range LANs is that they cannot communicate long distances. However, this limitation can be partially overcome by configuring each EVSE 304 as a “relay” such that any EVSE 304 will relay communications to another EVSE 304. This allows EVSEs 304 charging in the same vicinity to communicate together in the same network as long as each EVSE antenna 312 can reach at least one other antenna 312 in the network.

EVSE 304 may also be configured to communicate via a long range wireless area network (WAN) standard. WiMAX, CDMA communications networks, and GSM communications networks are three examples. Long range WAN communication has the advantage of easy installation and predefined coverage areas. The coverage areas generally coincide where electric vehicle charging stations will be placed.

EVSE 304 may also be configured to communicate via power line modem, using the power line as a transmission medium to conduct a signal between any two points on the power line. This system has the advantage of using power lines that are already in place.

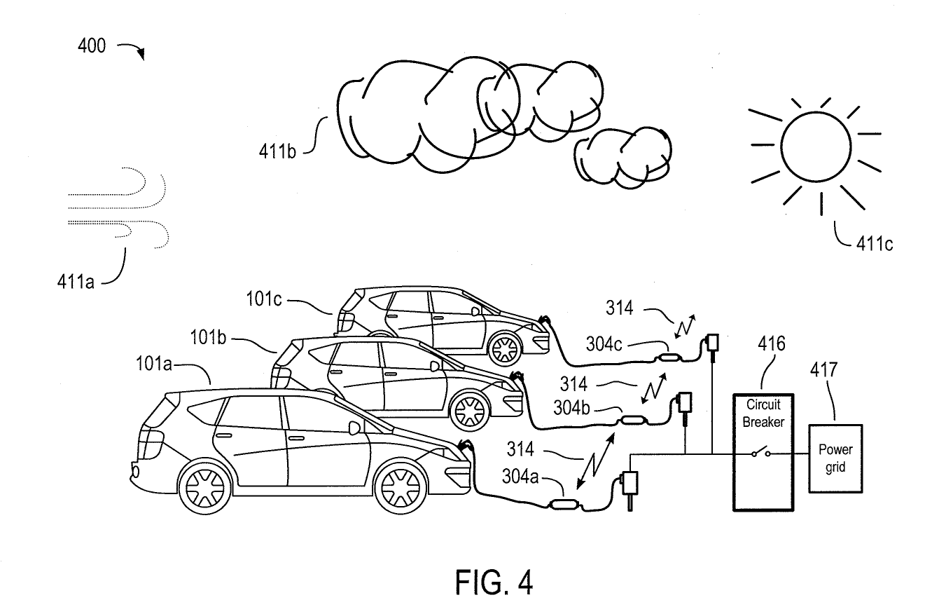

FIG. 4 illustrates an exemplary electric vehicle charging system 400 including a plurality of electric vehicles 101 utilizing intelligent EVSEs 304. In this implementation, electric vehicle charging system 400 includes three electric vehicles 101a, 101b, and 101c. Each of the electric vehicles 101 has a corresponding EVSE 304a, 304b, and 304c respectively. In this implementation, the EVSEs 304 are configured to send broadcast signals 314. Each EVSE 304 receives power from power grid 417 which is protected by circuit breaker 416. Each controller 308 (not shown) of the EVSEs 304 is configured to adjust power based on the environment 411. In this implementation, EVSEs 304 include a wind speed sensor to sense wind 411a. EVSEs 304 further include an ambient light sensor to detect clouds 411b. And EVSEs 304 further include a UV light sensor to detect sun light 411c. EVSEs 304 are configured to use information about the environment 411 to adjust the amount of power drawn by EVs 101 as described herein.

Furthermore, EVSEs 304 include antennas 312 (not shown) configured to send broadcast signals 314 which allows EVSEs 304 to operate according to a cooperative charging policy. One benefit of this implementation is that the cooperative charging policy allows EVSEs 304 to charge all electric vehicles 101 without overloading and tripping circuit breaker 416. Another benefit is that EVSEs 304 are able to reduce their power draw during peak times of the day or when the environment is indicative of increased load on power grid 417.

One benefit of an EVSE 304 configured in this way is that it can be used by a utility or power management entity to indirectly control EV charging during peak load times. The utility entity can make EVSEs 304 available to their customers, perhaps at a reduced cost. The utility benefits by gaining control over peak loads by using one or more of the configurations described herein, or any other similar configuration where applicable, to reduce power usage during peak demand times. Such controls may prevent the utility entity from having to startup expensive peaker power plants. Peaker power plants are used to cover the excess amount of power required during peak-demand periods. Peaker plants are more typically more expensive to operate and account for a portion of the increased costs during peak hours. An EVSE 304 as described herein also benefits the utility entity's customers by lowering their energy bills since their energy usage will occur during cheaper, off-peak hours.

Furthermore, although EVSE 304 may operate independent of any operator control or internet access as disclosed above, such features may also be included. In one implementation, EVSE 304 comprises a connection to the network and controller 308 is configured to allow for operator control via the network. In this implementation, EVSE 304 receives command signals from an operator that controls the amount and timing of charging. EVSE 304 is configured to send status and charging information back to the operator. In another implementation EVSE 304 allows for local user control. EVSE 304 comprises an interface to allow a user to view and change the charging parameters. For example, a user may select a “polite” mode indicating that power should be limited to off-peak demand periods and that other EVSEs 304 may charge first. A user may also select a “desperate” mode indicating that full power should always be drawn. Other charging modes would allow a user to opt out of cooperative charging with other EVSEs 304. Or a user may select to never charge during peak periods, or to only charge when the electricity billing rate is below a set amount. In an implementation where EVSE 304 is connected to the internet, the user may receive a message indicating when charging is being discontinued. In one implementation, EVSE 304 provides an interface to allow the user to set their charging parameters over the internet.

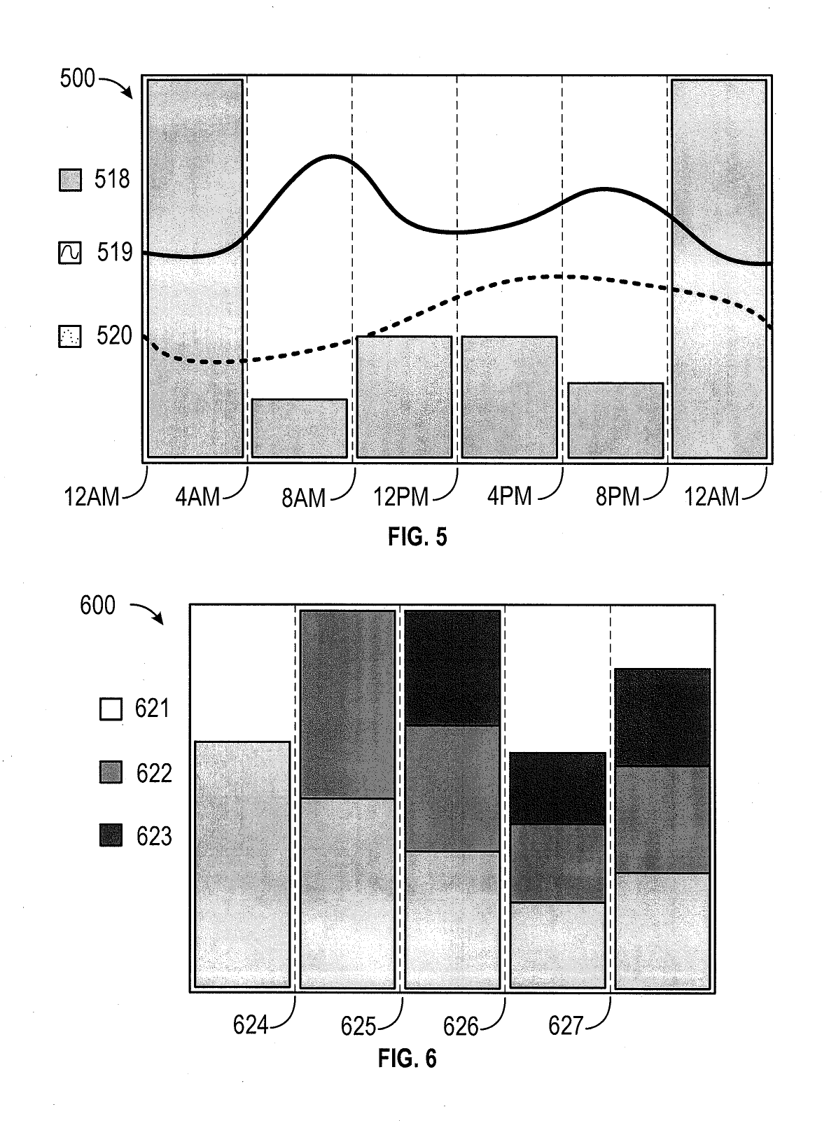

FIG. 5 shows a chart of peak power demand and electric vehicle power consumption. Peak power demand chart 500 graphs two curves of possible power demand on the power grid 417 at certain times of the day. Solid line 519 corresponds to a possible power demand curve during the winter season with one morning peak at 7 AM and one evening peak at 6 PM. Dotted line of power demand 520 corresponds to a possible power demand curve during the summer season with a longer peak demand lasting all afternoon and into the evening from 12 PM to 7 PM. Amount of power drawn 518 corresponds to the amount of power drawn by an electric vehicle charger 103 being supplied by an intelligent EVSE 304 which is configured to adjust the amount of power drawn in response to winter peak power demand 519. EVSE 304 is configured to adjust the amount of power drawn 518 according to the implementations described above. The amount of power drawn 518 is drawn set to full power from 8 PM to 4 AM but is reduced from 4 AM to 8 AM as power demand on the grid increases as shown by power demand line 519. Power drawn 518 may be increased to less than full power from 8 AM to 4 PM as power demand 519 decreases. Power drawn 518 may then be reduced in response to the second peak of power demand 519 from 4 PM to 8 PM. In this illustration the electric vehicle 101 is being charged throughout the day, but this situation would not likely occur in reality because the EV 101 will become full charged at some point in time or the EVSE will be disconnected to allow use of the EV 101. However, this illustration is just one example of an intelligent EVSE 304 adjusting power in response to expected power demands based on information received from environment sensors 310. A person of skill in the art will understand that intelligent EVSE 304 may be configured to adjust the amount of power drawn in response to any method of predicting power demand.

FIG. 6 shows a chart of electric vehicle power draw between a plurality of electric vehicles. Cooperative charging chart 600 depicts the amount of power drawn by a first EV 621, the amount of power drawn by a second EV 622, and the amount of power drawn by a third EV 623. In this implementation, the three electric vehicles 101 are all charging from power supplied through the same circuit breaker 416 and are configured with antennas 312 as described above. The three corresponding intelligent EVSEs 304 are operating according to a cooperative charging policy in order to adjust the amounts of power drawn 621, 622, and 623. In this implementation, the initial amount of power drawn by the first EV 621 is its full charging power, the full charging power being less than the maximum power available from the circuit breaker 416. At first time 624 the second EV begins charging at an amount of power 622 according to the cooperative charging policy which has been redefined. The cooperative charging policy is now defined to reduce the amount of power drawn by the first EV 621 and to set the second EV to draw an amount of power 622 that is below its maximum charging rate. The charging levels are reduced to prevent circuit breaker 416 from tripping. In this implementation, the cooperative charging policy is defined to evenly distribute power among the electric vehicle chargers. At second time 625 a third EV beings charging and the cooperative charging policy is redefined again. The first and second EV further reduce the amounts of power drawn 621 and 622 accordingly. The third EV beings charging at an amount of power 623 that is lower than its maximum charging rate accordingly. At third time 626 the three EVs detect generated signals 334 from their environmental sensors 310 indicating a higher power demand on the grid and reduce the amounts of power drawn 621, 622, 623 accordingly. At fourth time 627 the generated signals 334 indicate less power demand and the amounts of power drawn 621, 622, and 623 are increased proportionally.

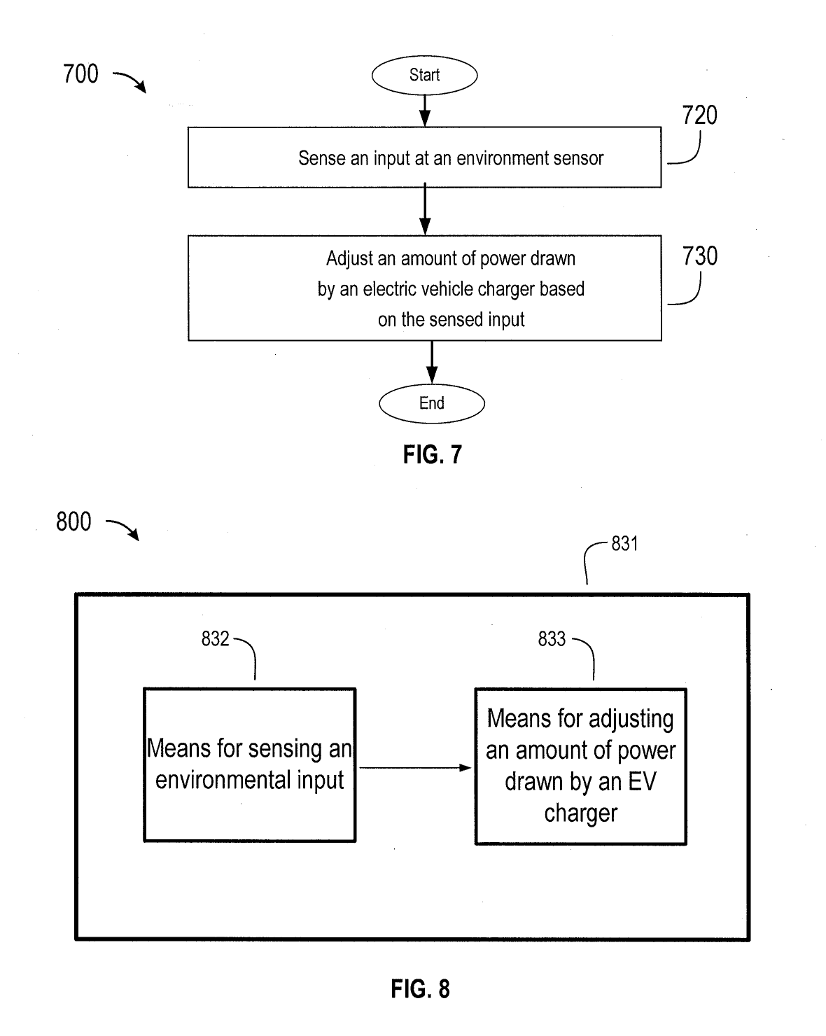

FIG. 7 shows a flowchart 700 for an exemplary method for charging an electric vehicle. At the start, an EVSE 304 may be connected to an electric vehicle charger 103. In block 720 an input is sensed at an environment sensor 310. As described above, the environment sensor 310 may comprise a clock, a temperature sensor, an ambient light sensor, an ultra-violet light sensor, a humidity sensor, a wind speed sensor, or a barometric sensor. At block 730 the EVSE 304 adjusts an amount of power drawn by electric vehicle charger 103 based on the sensed input in block 720. The adjustment of the amount of power drawn by electric vehicle charger 103 in block 730 may be implemented according to any implementation described herein. In one implementation, adjusting an amount of power drawn includes adjusting transmission of a pilot signal 209 based on the sensed input, where pilot signal 209 indicates an available continuous current capacity.

This method may also further include a third block (not shown) of transmitting and receiving broadcast signals 314 via a personal area network and a fourth step (not shown) of operating according to a cooperative charging policy for dividing power among a plurality of electric vehicle chargers 103 based on the received broadcast signals 314. As described above, the cooperative charging policy may be defined to reduce power to the highest powered EV chargers 103, or to reduce power to the EV chargers 103 that are the closest to being fully charged, or to reduce power randomly or evenly, or to adjust power only to EV chargers 103 that share a circuit.

FIG. 8 shows a block diagram 800 of an exemplary device for charging. Device 831 includes means for sensing an environmental input 832 and means for adjusting an amount of power drawn by an electric vehicle charger 833 based on the sensed input. Device 831 may be configured as an EVSE 304 as described above with the means for sensing an environmental input 832 comprising an environmental a sensor 310 and the means for adjusting an amount of power drawn by an electric vehicle charger 833 comprising a controller 308. However, means for sensing an environmental input 832 may comprise any other means for sensing an input and means for adjusting an amount of power drawn by an electric vehicle charger 833 may comprise any other means for adjusting an amount of power. The adjustment of the amount of power drawn by electric vehicle charger 103 may be implemented as described above.

A person having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

What is claimed is:

1. A device for delivering power, comprising:
an environment sensor configured to sense an input and generate a signal indicative of the sensed input; and
a controller operably connected to the environment sensor and configured to cause an adjustment of an amount of power drawn by an electric vehicle charger based on the generated signal.

2. The device of claim 1, wherein the environment sensor is configured to sense an input local to a parking area in which the sensor is located.

3. The device of claim 1, wherein the controller is configured to cause the adjustment of the amount of power drawn by adjusting transmission of a pilot signal based on the generated signal, the pilot signal indicating an available line current, wherein the controller is configured to adjust transmission of the pilot signal by changing the pilot signal or by selectively discontinuing the pilot signal.

4. The device of claim 1, wherein the sensor is further configured to sense a voltage drop at an output, and wherein the generated signal is indicative of the voltage drop being below a threshold, and wherein the controller is further configured to cause a reduction in the amount of power drawn by the charger in response to the voltage drop being below the threshold.

5. The device of claim 1, wherein the sensor is further configured to determine at least one of a time of day and a temperature, and wherein the controller is further configured to determine if at least one of the time of day and the temperature correspond to a peak energy demand and cause a reduction in the amount of power drawn in response.

6. The device of claim 1, wherein the sensor comprises at least one of a clock, a temperature sensor, an ambient light sensor, an ultra-violet light sensor, a humidity sensor, a wind speed sensor, or a barometric sensor.

7. The device of claim 1, further comprising an antenna operably connected to the controller and configured to transmit and receive signals from a plurality of other devices for delivering power via a network, wherein the controller is further configured to cause the adjustment of the amount of power drawn by the electric vehicle charger based on a received signal according to a cooperative charging policy for dividing power among a plurality of electric vehicle chargers.

8. The device of claim 7, wherein the charging policy is defined to reduce power to at least one of:
the highest powered chargers of the plurality of chargers;
the chargers that are closest to being fully charged; or
chargers that share a circuit.

9. The device of claim 7, wherein the charging policy is defined to reduce power at least one of randomly or evenly.

10. A method for delivering power, comprising:
sensing an input via an environment sensor; and
adjusting an amount of power drawn by an electric vehicle charger based on the sensed input.

11. The method of claim 10, wherein adjusting an amount of power drawn comprises adjusting transmission of a pilot signal based on the sensed input, the pilot signal indicating an available line current wherein the adjustment of pilot signal further comprises selectively adjusting the pilot or selectively discontinuing the pilot signal.

12. The method of claim 10, wherein the sensor is configured to sense a voltage drop at an output, and wherein the sensed input is indicative of the voltage drop being below a threshold, and wherein the adjustment of the amount of power drawn is configured to cause a reduction in the amount of power drawn by the charger in response to the voltage drop being below the threshold.

13. The method of claim 10, wherein the sensor is configured to determine at least one of a time of day and a temperature, and wherein the adjustment of the amount of power drawn is configured to cause a reduction in the amount of power drawn in response to at least one of the time of day and the temperature corresponding to a peak energy demand.

14. The method of claim 10, wherein the sensor comprises at least one of a clock, a temperature sensor, an ambient light sensor, an ultra-violet light sensor, a humidity sensor, a wind speed sensor, and a barometric sensor.

15. The method of claim 10, further comprising transmitting and receiving signals via a network, wherein the amount of power drawn is adjusted based on a received signal according to a cooperative charging policy for dividing power among a plurality of electric vehicle chargers.

16. The method of claim 15, wherein the charging policy is defined to reduce power to at least one of:
the highest powered chargers;
the chargers that are closest to being fully charged; or
chargers that share a circuit.

17. The method of claim 15, wherein the charging policy is defined to reduce power at least one of randomly or evenly.

18. A device for delivering power, comprising:
means for sensing an environmental input; and
means for adjusting an amount of power drawn by an electric vehicle charger based on the sensed environmental input.

19. The device of claim 18, wherein the sensing means is configured to sense a voltage drop at an output, and wherein the sensed input is indicative of the voltage drop being below a threshold, and wherein the adjustment of the amount of power drawn is configured to cause a reduction in the amount of power drawn by the charger in response to the voltage drop being below the threshold.

20. The device of claim 18, further comprising means for transmitting and receiving signals via a network, where the means for adjusting an amount of power drawn is configured to adjust power based on a received signal according to a cooperative charging policy for dividing power among a plurality of electric vehicle chargers.
